(19) United States
(12) Patent Application Publication
(10) Pub. No.: US 2007/0276716 A1
(43) Pub. Date: Nov. 29, 2007

(54) Method For Retrieval of Available Intervals

(76) Inventors: Akihiro Kosugi, Tokyo (JP); Norimasa Hayashida, Tokyo (JP)

Correspondence Address: LIEBERMAN & BRANDSDORFER, LLC, 802 STILL CREEK LANE, GAITHERSBURG, MD, 20878, US

(21) Appl. No.: 11/420,314

(22) Filed: May 25, 2006

(51) Int. Cl. G06F 9/46

(52) U.S. Cl. 705/8

(57) ABSTRACT

A method and system are provided for automating scheduling of a plurality of resources. Initially, the resources that are potential candidates for scheduling are selected, and a time interval for scheduling the selected resources is submitted. Scheduling results are determined by automatically concatenating the availability of the resources based upon the submitted time interval. The scheduling results are presented to a user with the presentation of the results illustrating the availability of the selected resources.

### BACKGROUND OF THE INVENTION

1. Technical Field

This invention relates to scheduling resources. More specifically, a plurality of resources are selected for scheduling and an optimal time range is returned based upon availability and criteria applied to the resources.

2. Description of the Prior Art

In the modern workplace environment, individuals have specific skill sets and resources that they contribute. Meetings among individuals or groups are common in the workplace to gather information on past, present, and future projects. There are many scheduling programs available to assist in compiling schedules associated with individuals representing different skill sets required for a meeting. FIG. 1 is a flow chart (10) illustrating a prior art process for selecting and scheduling resources based upon availability of the resource. Initially, the individual resources are selected (12). For example, in one embodiment, the individual resources may be selected from a directory of resources. Following the selection of the resources at step (12), the person initiating the selection and scheduling process applies the duration in which they require the availability of the selected resource (14). Based upon the information input at steps (12) and (14), results are provided with the availability or the unavailability for each resource requested (16). Accordingly, the prior art scheduling process retrieves all the specified resources and associated individuals representing those resources, together with the potential time periods when the resources are available.

However, as shown in FIG. 1, there is no automated process for amending schedules of the requested resources. With prior art, you may need to submit a request multiple times changing the attendees of the request, and concatenate the results manually to try to schedule the selected resources based upon availability of specified resources at select time intervals. There is no automated process to apply criteria to the selected resources within the duration of scheduling time provided. Accordingly, there is a need for a method and apparatus that facilitates automated scheduling of multiple resources.

### SUMMARY OF THE INVENTION

This invention comprises a method and apparatus for automatically and efficiently scheduling resources.

In one aspect of the invention, a method is provided for scheduling resources. The method includes selecting resources from a pool of available resources to be scheduled, and submitting a time interval for querying the resources that have been selected. Based upon the selection and time interval submitted, the results of the selected resources and time interval are automatically concatenated.

In another aspect of the invention, a computer system is provided for automating the process of scheduling a plurality of resources. A plurality of resources that are available to be scheduled are provided. In addition, a time interval is provided and submitted as a query for availability of the resources. A manager automatically concatenates results of the selected resources for the submitted time interval.

In yet another aspect of the invention, an article in a computer-readable medium is provided. The article includes instructions in the medium for selecting resources for scheduling, and instructions in the medium for submitting a time interval for querying the selected resources. In addition, instructions in the medium are provided for automatically concatenating results of the selected resources for the submitted time interval.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art block diagram of a scheduling procedure.

FIG. 2 is a block diagram of an automated scheduling procedure according to the preferred embodiment of this invention, and is suggested for printing on the first page of the issued patent.

FIGS. 3a and 3b are block diagrams illustrating selection of resources for scheduling.

FIG. 4 is a block diagram illustrating a sample user interface following selection of criteria to a group of resources and an identified time range.

FIGS. 5a and 5b are block diagrams illustrating a sample user interface following selection of criteria with one of the resources in a group identified as required.

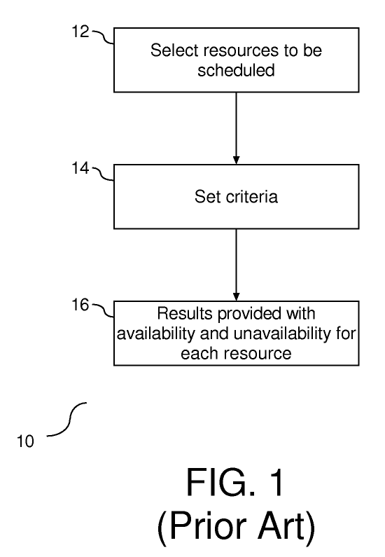

### DESCRIPTION OF THE PREFERRED EMBODIMENT

### Technical Details

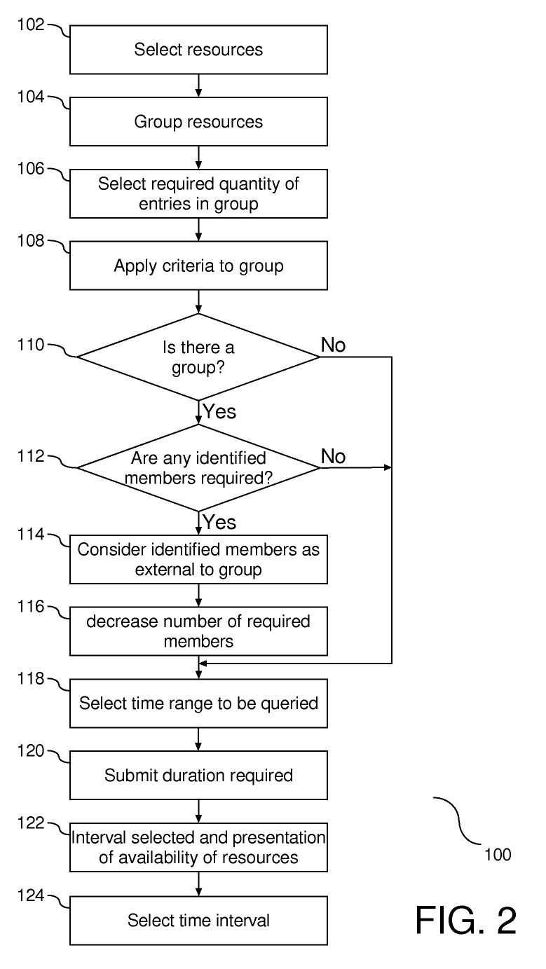

FIG. 2 is a flow chart (100) illustrating a process for scheduling multiple resources. Initially, the resources required for the schedule are selected from a list of multiple resources (102). Thereafter, the entire selection of resource or a portion of the selected resources are placed into one or more groups (104). Each group in the scheduling process is managed as an element of the request. For example, the selection of resources may include seven individuals, and the grouping process may place four of the seven individual in a single group. In one embodiment, a single group may only have a single resource. The grouping of resources in the selection process provides for a selection of the required number of entries in each specified group for the schedule (106). There may be circumstances when individuals within a group may contribute overlapping resources and thus the selection may only require a specified number of individuals within the group wherein the specified number is less than the entire group. At the same time, additional circumstances may require that resources that are not within a set group may be required for the scheduling process. Following step (106), criteria is applied for selection of a quantity of resources within each formed group (108). In one embodiment, criteria may be in the form of specifying any one or more resources within a formed group as a mandatory resource for scheduling. This process also enables selection of a required quantity of members from a formed group. At the same time, if specific individual resources are not placed in the group, it may be specified that such resources are required and not optional for the selection process.

Following the process of identifying resources and applying criteria to the selected resources, it is determined if any of the selected resources have been placed in a group (110). A positive response to the test at step (110) will result in a test to determine if any members of the group have been identified as a required resource for the scheduling process (112). If the response to the test at step (112) is positive, each identified member of the group is considered as external from the group for scheduling purposes (114), and the number of required members in the group is decreased by the number of identified members external to the group (116). Following step (116) or a negative response to the tests at steps (110) or (112), the time range for scheduling the selected resources is queried (118) and the duration for the meeting to be scheduled is submitted (120). The information is received and a user interface presents one or more time intervals available for the required and optional resources for the event to be scheduled event (122). Thereafter, the user may select one of the time intervals presented to reserve the select resources (124).

In one embodiment, an application server is employed with a schedule repository to facilitate scheduling of resources. Based on the principles outlined in FIG. 2 above, a client submits a request to the server for scheduling. The request includes resources of a participation unit, the retrieval requirement accompanying the resources, and the retrieval requirements for the retrieval range. The resources of a participation unit may be the members of a group of select resources. The retrieval requirement may include the number of matches that are required for scheduling, and the retrieval requirements for the retrieval range may include the start, duration, and end times of the meeting to be scheduled. In one embodiment, a confirmation receipt of the schedule of resources is provided for each retrieval factor on the time axis provided. If the server finds a free time interval for each selected resource which matches each of the retrieval requirements within the time frame specified, the server may increase the free time interval range counter by one and consider any factor that has exceeded the threshold specified for the retrieval requirements as a free time interval of a participation unit. A result set of the required retrieval conditions is sent to the client. In one embodiment, the result set may include the time range that is a product set of free time interval ranges that have been derived for each retrieval factor and which corresponds to each of the retrieval requirements.

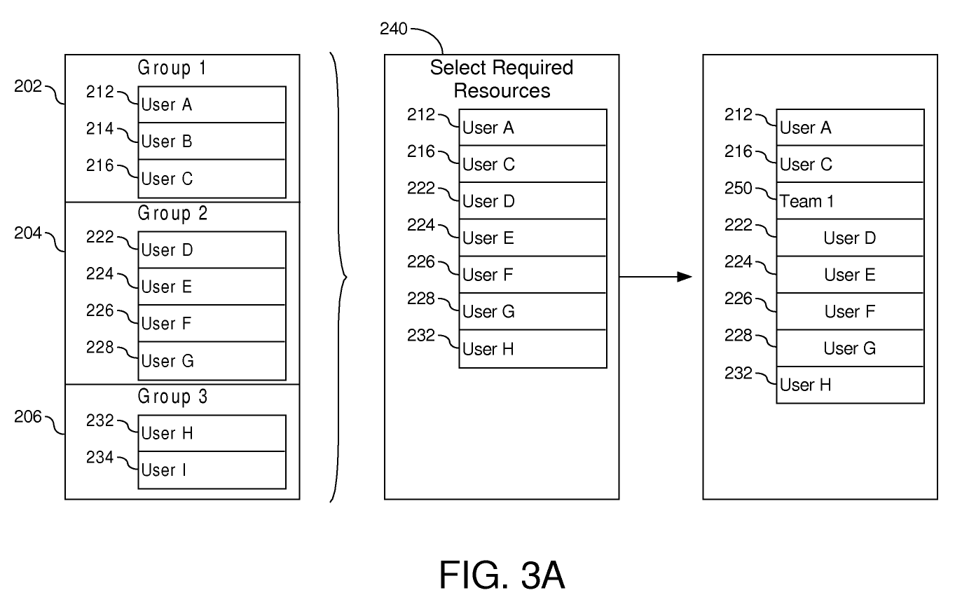

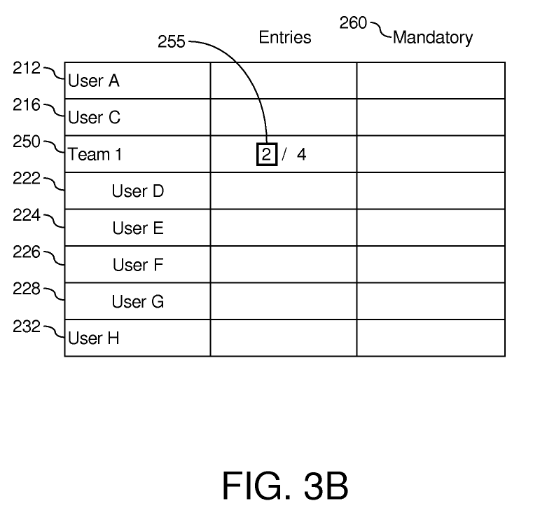

FIG. 3A is a block diagram (200) illustrating selection of resources for scheduling. As shown, initially there are three groups of resources (202), (204), and (206) with a total of nine resources in the three groups. The first group (202) has three resources (212), (214), and (216). The second group (204) has four resources (222), (224), (226), and (228). The third group (206) has two resources (232) and (234). The quantity of groups and resources in each of the groups shown herein is merely an example for illustrative purposes. In one embodiment, the quantity of groups and resources within the groups may be increased or decreased. As shown at step (102), the resources required for the scheduling are selected. A selection of resources from the three groups is shown at (240). In the example shown herein, seven resources have been selected for scheduling (212), (216), (222), (224), (226), (228), and (232). Following the selection at step (102), resources within the selection may be placed in one or more groups. In the example shown herein, four of the selected resources (222), (224), (226), and (228) are placed into a group (250). As shown, there are four entries in the group (250). In one embodiment, criteria (245) may be applied to indicate that select members of the group (250) are required for scheduling. If any of the members of the group are identified as required, they are in fact considered as a resource for scheduling external to the identified group of resources. Similarly, as shown as step (106), a select quantity of resources within the group may be identified as necessary for scheduling. For example, as shown in FIG. 3B, it may be that only two out of the four members in the group are necessary. Item (255) shows an example in which only two entries in the group are required for scheduling. In this case, there may be some added flexibility in determining availability of select resources for scheduling if neither of the resources in the group are identified as a required member. Another option is to delineate if any of the members of the group are required to be present for scheduling. As shown at (255), the selection criteria may identify the quantity of members of the team required for scheduling, and at (260), one or more of the quantity of members may be specifically identified as required.

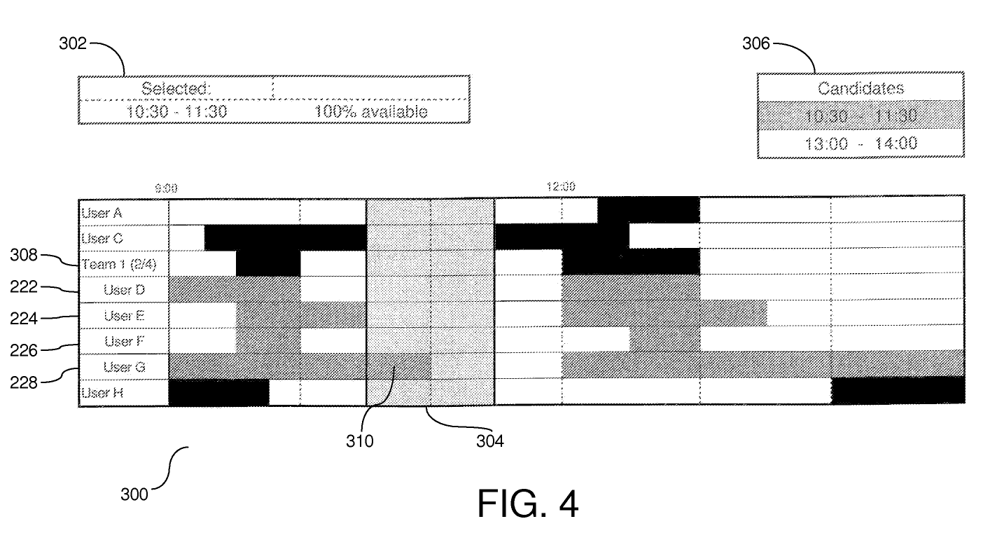

As noted at step (118) in FIG. 2, the user may select a time range to query the selected resources. FIG. 4 is a block diagram (300) showing a sample user interface following selection of criteria to be applied to a group of resources and an identified time range. As shown at (255) in FIG. 3B, this example places a restriction on two entries from the grouped resources. In FIG. 4, the time frame has been provided, as shown at (302), for a duration of one hour together with the candidates displayed in a text list (306). In the example shown in FIG. 4, the selection only requires two members of Team 1 (308), with four members (222), (224), (226), and (228) that comprise Team 1. The example interface displays the resource selection in a vertical alignment and the time schedule in a horizontal alignment. Each shaded section in the interface displays is an indication that the associated resource is not available for the associated time interval. For example, in FIG. 4, a selection of resources are all designated as being available for the required time frame (304). The time frame of 10:30-11:30 shows all resources available with the exception of User E (224), which is unavailable from 10:30-11:30, as indicated at (310). Since the criteria in this example indicated that only two members of Team 1 (308) are required, the selected time interface of 10:30-11:30 meets the selection requirement.

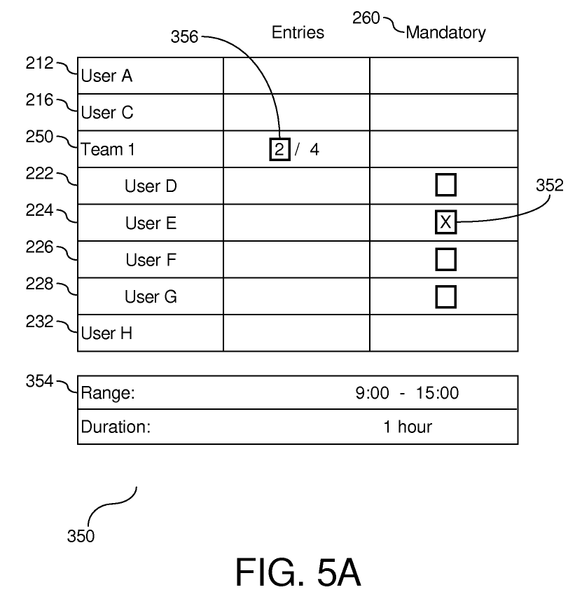

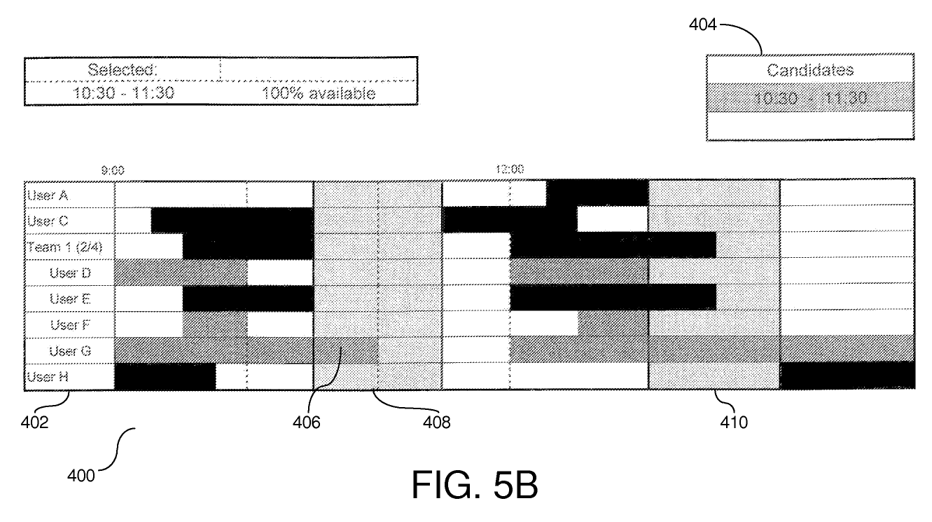

FIG. 5a is a block diagram (350) showing a sample user interface following selection of criteria applied to a group of resources (212), (216), (250), (222), (224), (226), (228), and (232). Four of the resources (222), (224), (226), and (228) are shown placed in a group designated as Team 1 (250). Within Team 1 (250), it is shown that two resources are required (356), but these two resources are not specifically designated with the exception of User E (224) that is designated as a required resource (352). In addition, the time range (354) provided in this selection is broad with a duration of one hour, with start and end times between the hours of 9:00 and 15:00. FIG. 5b is a graphical illustration (400) of a user interface and presentation. In the example shown in FIG. 5b, the selection only requires two members of Team 1 (308), with User E (224) designated as a required resource. The example interface displays the resource selection in a vertical alignment and the time schedule in a horizontal alignment. Each shaded section in the interface displays is an indication that the associated resource is not available for the associated time interval. For example, in FIG. 5b, a selection of resources shows a time frame of 10:30-11:30 with all resources designated as being available, as indicated at (408), except for User G (228). Similarly, a time frame of 13:00-14:00 (410) shows User E (224) and User G (228) as being unavailable. As shown, the time interval of 10:00-10:30 shows User G (228) as unavailable as indicated at (406) with shaded coloring. Since the criteria in this example indicated that only two members of Team 1 (250) are required with User E (224) designated as a specific requirement, the selected time interval of 10:30-11:30 (408) meets the selection requirement while the time interval of 13:00-14:00 (410) does not meet this requirement. The results are presented to the user with a list of resources available for the time range provided that abide by the factor for the schedule. From among the results, the user selects available resources for the time interval and sets the start time for the meeting.

The retrieval results may be provided to the user in different formats. In one embodiment, the retrieval results are provided in a string list. The list includes retrieval of the free time intervals with a start time and end time, and a quantity of resources that are available for each time interval. From among the results list, the user may select resource, i.e. candidates, to be used for a select start time of the shared schedule. Based on the principles outlined above, the results are concatenated based upon availability of resources, selection of resources, and a specified time interval.

In one embodiment, the percentage of availability for each participation unit in each time period is displayed in a graphical user interface with color differentiation provided to display depth of availability. For example, for calculation of color depth, an HSB (hue, saturation, and brightness) coefficient may be used. The brightness may be changed based upon the percentage of resources available as follows:

Brightness=Minimum of ((Number of possible participants in the relevant participation unit)/(Number of called members in the relevant participation unit))*100%

For example, in a gray scale environment where all select resources are available to participate the two extreme colors of the spectrum are white and black. The availability of more resources will provide a color closer to white. Similarly, unavailability of select resources will provide a color closer to black. As shown in FIG. 5, the rectangular bar (356) is displayed in gray scale showing the availability of resources for a select time frame. Each of the selected resources are available from 10:00-10:30. The depth of the color of the bar (356) shows the average value representing the availability percentage in each participation unit of select resources. In one embodiment, the user may move the rectangular bar (356) to change the selected time interval. If the availability of selected resources changes, the color of the bar (356) will change to reflect availability of the resources. In addition, if a status indicator is available, this indicator may change to reflect the position of the bar (356) and availability of resources.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

### ADVANTAGES OVER THE PRIOR ART

An automated system is provided for selecting multiple resources and scheduling an appointment for the resources selected. In one embodiment, a user may indicate which of the select resources are required for the appointment, which resources are optional, and/or the number of resources required. Based upon the scheduling parameters provided and availability of the selected resources, the results are concatenated and presented to the user. In one embodiment, a graphical presentation is provided to graphically show availability of the selected resources. The graphical presentation may provide a numerical percentage of available resources, and/or a vertical bar in a color wherein the hue of the color indicates the percentage of available resources for the time frame provided.

### Alternative Embodiments

It will be appreciated that, although specific embodiments of the invention have been described herein for purposes of illustration, various modifications may be made without departing from the spirit and scope of the invention. In particular, gray scale and color may be used to graphically show availability of select resources. However, in one embodiment, an area on the display may be designated to show information of the selected time period and a numerical value to represent the availability percentage of the designated resource. By the depth of color in the rectangle or the numerical value of selected resources, a user can visually understand how appropriate the selected time period is for the start time of the possible shared schedule. Accordingly, the scope of protection of this invention is limited only by the following claims and their equivalents.

We claim:

1. A method for scheduling resources, comprising the steps of:
selecting resources for scheduling;
submitting a time interval for querying said selected resources; and
automatically concatenating results of said selected resources for said submitted time interval.

2. The method of claim 1, wherein the step of selecting resources for scheduling includes grouping resources.

3. The method of claim 2, further identifying required resources in said grouping.

4. The method of claim 1, further comprising presenting said concatenated results in a graphical format.

5. The method of claim 4, wherein said graphical format includes a brightness factor as an indicator of percentage of available resources.

6. The method of claim 5, further comprising changing said selection of resources and said submitted time interval on said graphical format, and reflecting said change through said brightness factor.

7. A computer system comprising:
a plurality of resources available to be scheduled;
a time interval to submit as a query for availability of said resources; and
a manager to automatically concatenate results of said resources for said submitted time interval.

8. The system of claim 7, wherein said plurality of resources are placed into groups.

9. The system of claim 8, further comprising said identification of required resources in each of said groups.

10. The system of claim 7, further comprising said manager presenting said concatenated results to a user in a graphical format.

11. The system of claim 10, further comprising a brightness factor associated with said graphical format as an indicator of a percentage of available resources.

12. The system of claim 11, further comprising a change in said scheduled resources and said time interval on said graphical format, wherein said change is reflected in said brightness factor.

13. An article comprising:
a computer-readable medium;
instructions in the medium for selecting resources for scheduling;
instructions in the medium for submitting a time interval for querying said selected resources; and
instructions in the medium for automatically concatenating results of said selected resources for said submitted time interval.

14. The article of claim 13, wherein said medium is a recordable data storage medium.

15. The article of claim 13, wherein said instructions for selecting resources for scheduling includes grouping resources.

16. The article of claim 15, further comprising instructions in the medium for identifying required resources in said grouping.

17. The article of claim 13, further comprising instructions in the medium for presenting said concatenated results in a graphical format.

18. The article of claim 17, wherein said graphical format includes a brightness factor as an indicator of percentage of available resources.

19. The article of claim 18, further comprising instructions in the medium for changing said selection of resources and said submitted time interval on said graphical format, and reflecting said change through said brightness factor.
